(19) United States
(12) Patent Application Publication
(10) Pub. No.: US 2011/0016041 A1
(43) Pub. Date: Jan. 20, 2011

(54) Triggering Fraud Rules for Financial Transactions

(76) Inventor: Ernest M. Scragg, Loveland, CO (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/834,793

(22) Filed: Jul. 12, 2010

Related U.S. Application Data
(60) Provisional application No. 61/225,485, filed on Jul. 14, 2009.

(51) Int. Cl. G06Q 40/00

(52) U.S. Cl. 705/38

(57) ABSTRACT

Embodiments of the invention provide a method to process a transaction. At least one risk factor associated with a consumer account can be triggered by the transaction. The risk factor intersects the transaction with an associated fraud rule, which is in turn applied to the transaction. Risk factors can be customized by an issuer using a user interface.

### CROSS-REFERENCES TO RELATED APPLICATIONS

This application claims the benefit of U.S. Provisional Patent Application No. 61/225,485, filed on Jul. 14, 2009, the entirety of which is incorporated herein by reference.

### BACKGROUND

Fraudulent transactions regarding credit cards and/or other similar payment mechanisms, such as debit cards, may result in huge losses. Criminals have learned to exploit gaps in conventional fraud detection techniques available to card issuers and the payment processing networks that process transactions for card issuers. Conventional fraud detection techniques may be too strict in some instances, resulting in legitimate transactions being declined, and a resulting loss of revenue. Conventional fraud detection techniques may also be too lenient in some instances, resulting in fraudulent transactions being processed.

Conventional fraud prevention techniques typically associate rules with tiered levels of cards. For example, all standard credit card accounts may be associated with certain rules, while all platinum card accounts may be associated with other rules. Tiered card levels do not indicate propensity or lack of propensity to engage in fraudulent behavior, but merely indicate spending limit ranges and associated tier benefits. Accordingly, conventional fraud prevention techniques do not provide flexibility in application, because all cardholder accounts of a specific tier are associated with the same set of rules.

Embodiments of the invention address these and other problems.

### BRIEF SUMMARY

Individual risk factors of a consumer account to trigger particular fraud rules for a transaction are disclosed. As an illustration, embodiments of the invention can relate to the idea of segmenting cardholder transactions and applying specific fraud rules to those segmented cardholder transactions. For example, cardholders that conduct transactions that are in the categories “high dollar” and “online shopping” may have one fraud rule applied to them, but transactions that are in a “new account” category may have a different rule applied to them.

One embodiment of the invention provides a method for processing a transaction. A payment request may be received to approve a transaction at a server computer. The transaction may be associated with a consumer account. At least one risk factor may be triggered from a plurality of risk factors associated with the consumer account, using the server computer. The at least one risk factor may be intersected with at least one fraud rule of a plurality of fraud rules, using the server computer. The at least one intersected fraud rule may be applied to the payment request, using the server computer.

Another embodiment of the invention provides a method for associating a fraud rule with a consumer account. At least one risk factor may be defined regarding potential payment requests of a consumer account, using a server computer. At least one fraud rule of a plurality of fraud rules may be associated with the at least one risk factor, using the server computer. At least one risk factor may be associated with at least one consumer account, using the server computer.

Yet, another embodiment of the invention is directed to respective computer readable mediums comprising instructions for respectively implementing the above-described methods when executed by a processor.

These and other embodiments of the invention are described in further detail below.

### BRIEF DESCRIPTION OF THE DRAWINGS

FIG. 1 is a schematic diagram of a system, for use with embodiments of the invention.

FIG. 2 is a schematic diagram of a payment processing network, according to an embodiment of the invention.

FIG. 3 is a schematic diagram of a computer system, for use with embodiments of the invention.

FIG. 4A is a flow diagram of a method for creating risk factors, according to an embodiment of the invention.

FIG. 4B is a screen shot of a user interface for creating risk factors, according to an embodiment of the invention.

FIGS. 5A and 5B are flow and system-level diagrams, respectively, of a method for processing a payment request, according to an embodiment of the invention.

### DETAILED DESCRIPTION

Embodiments of the invention provide risk factors which associate particular fraud rules with a transaction. Risk factors are one or more attributes of a consumer account associated with the transaction, or attributes of the transaction itself. Risk factors are preconfigured to be tied to a particular consumer account or particular group of consumer accounts. Risk factors are also preconfigured to intersect particular fraud rules with the transaction, if the risk factor is triggered by the transaction. The risk factors may be customizable by an issuer using a user interface.

### I. Exemplary System:

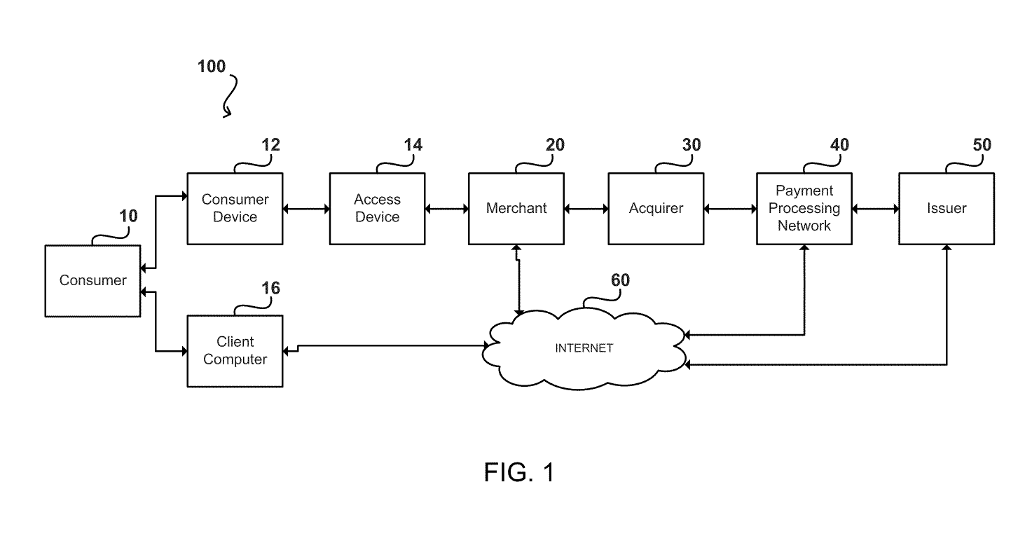

FIG. 1 shows a system 100 that can be used for conducting a payment transaction. The components in FIG. 1 may communicate via any suitable communication medium (including the internet), using any suitable communication protocol. System 100 can represent a standard payment request authorization model. As used herein, a “payment request” can include a request to authorize payment. It may be embodied by an authorization request message, which may contain information such as a payment account number, a transaction amount, a merchant category code, etc.

The system 100 includes a consumer 10 which may be an individual, or an organization such as a business that is capable of purchasing goods or services. The consumer 10 may operate a client computer 16. The client computer 16 can be a desktop computer, a laptop computer, a wireless phone, a personal digital assistant (PDA), etc., using any suitable operating system. The client computer may be used to interact with a merchant 20 (e.g., via a merchant Website).

The consumer 10 may also be associated with a portable consumer device 12. A consumer account associated with the portable consumer device 12 may be used for purchase transactions. Embodiments of the portable consumer device 12 may be in any suitable form. For example, suitable portable consumer devices can be hand-held and compact so that they can fit into a consumer's wallet and/or pocket (e.g., pocket-sized). They may include smart cards, ordinary credit or debit cards (with a magnetic strip and without a microprocessor) such as payment cards, keychain devices (such as the Speedpass™ commercially available from Exxon-Mobil Corp.), etc. Other examples of portable consumer devices include cellular phones, personal digital assistants (PDAs), pagers, stored value cards, security cards, access cards, smart media, transponders, and the like.

The merchant 20 may be an individual or an organization such as a business that is capable of providing goods and services. The merchant 20 may have a computer apparatus. The computer apparatus may comprise a processor and a computer readable medium. The computer readable medium may comprise code or instructions for sending a transaction clearing request and receiving a clearing return code.

The merchant 20 may have one or more access devices 14. Suitable access devices 14 include interfaces and may include point of sale (POS) devices, cellular phones, PDAs, personal computers (PCs), tablet PCs, handheld specialized readers, set-top boxes, electronic cash registers (ECR), automated teller machines (ATM), virtual cash registers (VCR), kiosks, security systems, access systems, and the like. If the access device 14 is a POS terminal, any suitable POS terminal may be used and may include a reader, a processor, and a computer readable medium. A reader may include any suitable contact or contactless entry mode of operation. For example, exemplary card readers can include radio frequency (RF) antennas, optical scanners, bar code readers, magnetic stripe readers, etc. to interact with portable consumer device 12. As another alternative, a consumer 10 may purchase a good or service via a merchant's Website where the consumer enters the credit card information into the client computer 16 and clicks on a button to complete the purchase. The client computer 16 may be considered an access device.

The system 100 also includes an acquirer 30 associated with the merchant 20. The acquirer 30 may be in operative communication with an issuer 50 of the consumer device 12 via a payment processing network 40. The acquirer 30 is typically a bank that has a merchant account. The issuer 50 may also be a bank, but could also be a business entity such as a retail store. Some entities are both acquirers and issuers, and embodiments of the invention include such entities. The acquirer 30 and the issuer 50 may each have a server computer and a database associated with the server computer.

The payment processing network 40 is located between (in an operational sense) the acquirer 30 and the issuer 50. It may include data processing subsystems, networks, and operations used to support and deliver authorization services, exception file services, and clearing and settlement services. For example, a payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services.

The payment processing network 40 may use any suitable wired or wireless network, including the Internet 60. The payment processing network 40 may have a server computer and a database associated with the server computer. The server computer may comprise a processor and a computer readable medium. The computer readable medium may comprise code or instructions for the methods disclosed herein.

For simplicity of illustration, one consumer 10, one consumer device 12, one client computer 16, one access device 14, one merchant 20, one acquirer 30, and one issuer 50 are shown. It is understood, however, that embodiments of the invention may include multiple consumers, consumer devices, client computers, access devices, merchants, acquirers, and issuers. In addition, some embodiments of the invention may include fewer than all of the components shown in FIG. 1.

In a typical transaction, an consumer 10 uses a consumer device 12 such as a payment card to interact with the access device 14 at the merchant 20. An authorization request message is generated by a processor in the access device 14 or and is sent to the payment processing network 40 via the acquirer 30. If the transaction is an online transaction, the client computer 16 can communicate with the merchant 20 via the Internet 60 and a computer at the merchant 20 can generate the authorization request message. Once received, the payment processing network 40 can perform appropriate fraud scoring and can send any fraud scores to the issuer 50 along with the authorization request message. Alternatively, the payment processing network 40 can simply deny the request of the fraud score indicates that the transaction is too risky.

If the authorization request message is approved by the issuer 50, the issuer 50 may generate an authorization response message and may sent it back to the access device 14 or the client computer 16 via the payment processing network 40 and the acquirer 30.

At the end of the day or other time, a clearing and settling process can occur.

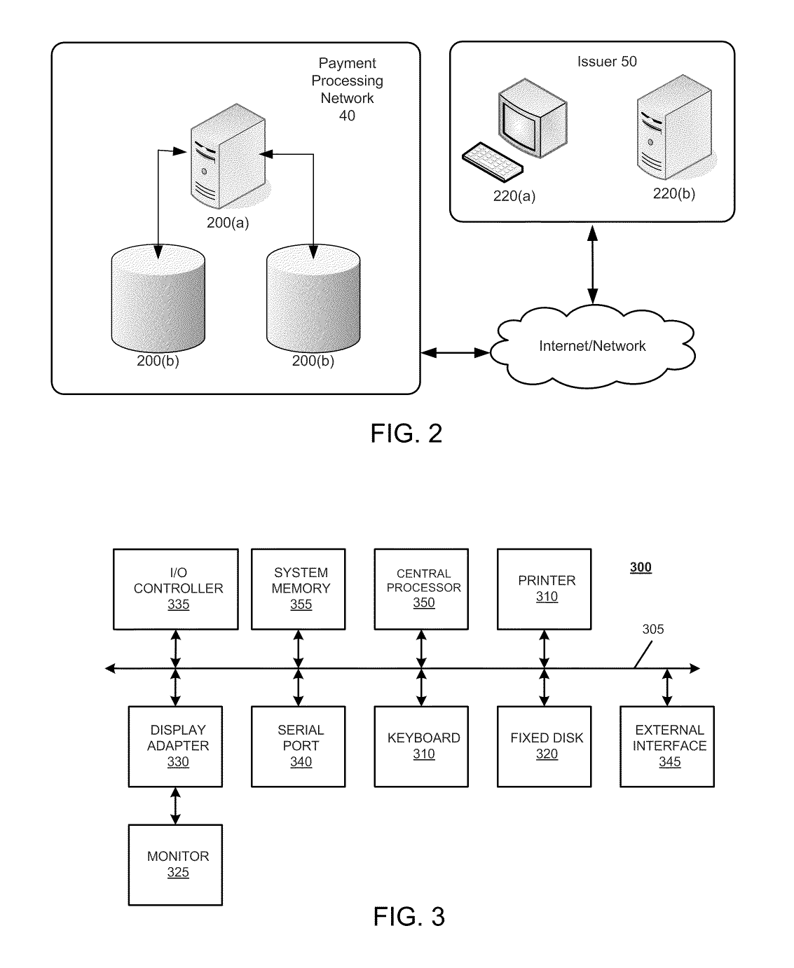

FIG. 2 is a high level block diagram of the payment processing network 40, according to an embodiment of the invention. Payment processing network 40 includes server computer 200(a), cardholder information database 200(b), and rules database 200(c). The server computer 200(a) may be a powerful computer apparatus or a cluster of computer apparatuses. For example, the server computer 200(a) can be a large mainframe, a minicomputer cluster, or a group of servers functioning as a unit. In one example, the server computer 200(a) may be a database server coupled to a Web server. The server computer 200(a) includes a computer readable medium (CRM) and a processor coupled to the CRM.

The issuer 50 may access the payment processing network 40 to update the cardholder information database 200(b) and rules database 200(c). The issuer 50 may access the databases using a user interface of a client computer 220(a) or remote server 220(b), both of which may be connected to the payment processing network 40 over the Internet or through a direct network connection. The payment processing network 40 may supply one or more user interfaces to the issuer 50 for interfacing with the payment processing network 40.

The server computer 200(a) is configured to receive a payment request, identify a consumer account associated with the payment transaction request, identify a risk factor associated with the consumer account, and to execute one or more fraud identification rules associated with the risk factor to determine whether to process or to decline the payment request. Cardholder information database 200(b) stores cardholder account information, such as account number, expiration date, etc. The rules database 200(c) stores fraud rules that may be associated with one or more risk factors. The fraud rules associated with a particular risk factor associated with a consumer account may be executed by server computer 200(a) in order to assess a payment transaction request originally sent from a merchant.

The server computer 200(a) may also associate a risk factor with each cardholder account on the cardholder information database 200(b). As described herein, card issuers and/or the payment processing network may define various risk factors for implementing specific fraud rules. If the payment transaction request fails to satisfy the rules associated with the risk factor for the consumer's account, the payment transaction may be declined or may be subject to additional scrutiny before being processed.

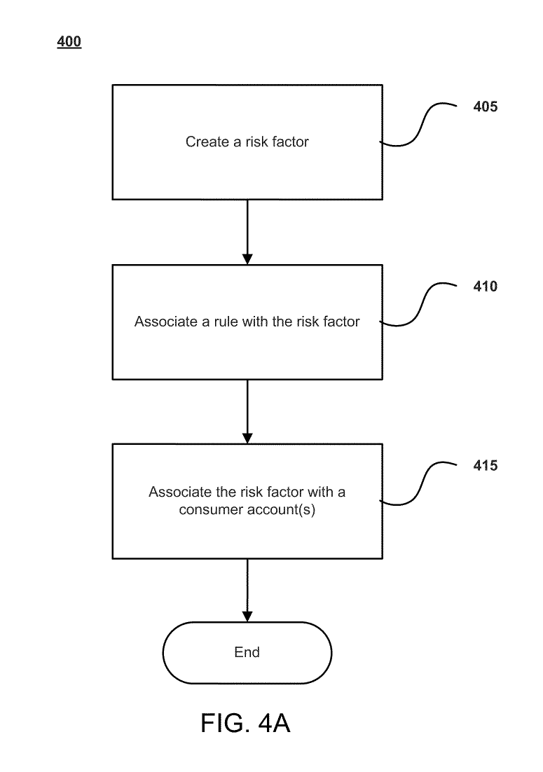

FIG. 3 is a high level block diagram of a computer apparatus 300 that may be used to implement any of the entities or components (e.g., client devices, server computers, etc.) described above, which may include one or more of the subsystems or components shown in FIG. 3. The subsystems shown in FIG. 3 are interconnected via a system bus 305. Additional subsystems such as a printer 310, keyboard 315, fixed disk 320, monitor 325, which is coupled to display adapter 330, and others are shown. Peripherals and input/output (I/O) devices, which couple to an I/O controller 335, can be connected to the computer apparatus 300 by any number of means known in the art, such as serial port 340. For example, serial port 340 or external interface 345 can be used to connect the computer apparatus 300 to a wide area network such as the Internet, a mouse input device, or a scanner. The interconnection via the system bus 305 allows the central processor 350 to communicate with each subsystem and to control the execution of instructions from system memory 355 or the fixed disk 320, as well as the exchange of information between subsystems. The system memory 355 and/or the fixed disk 320 may embody a computer readable medium.

### II. Risk Factors:

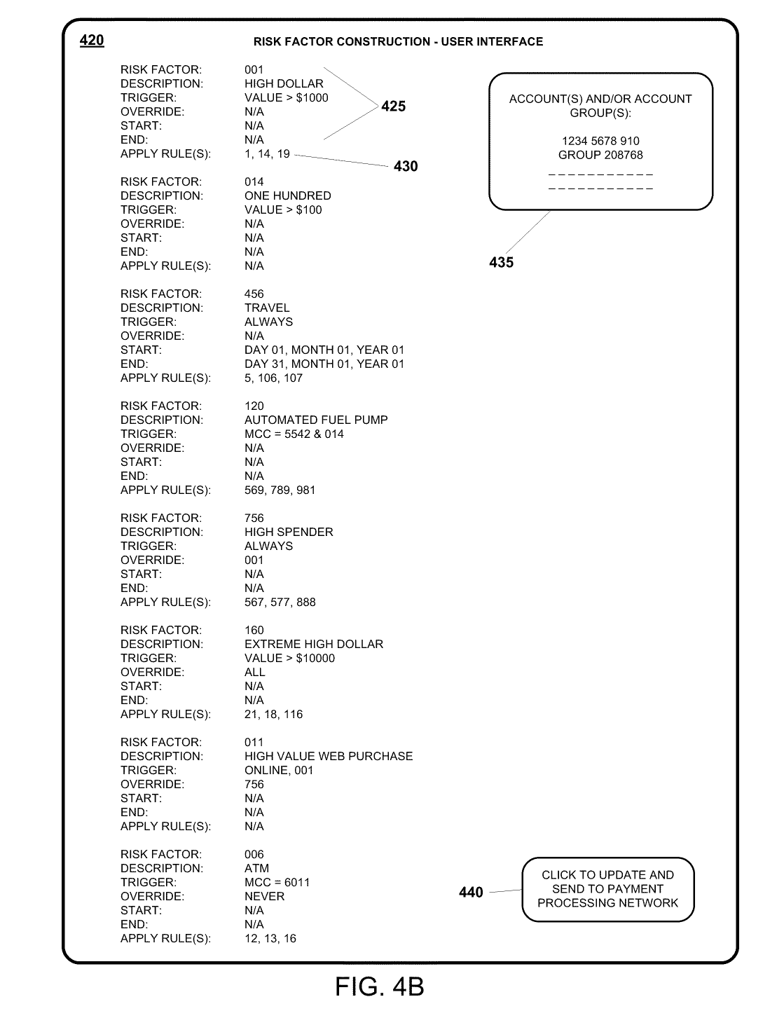

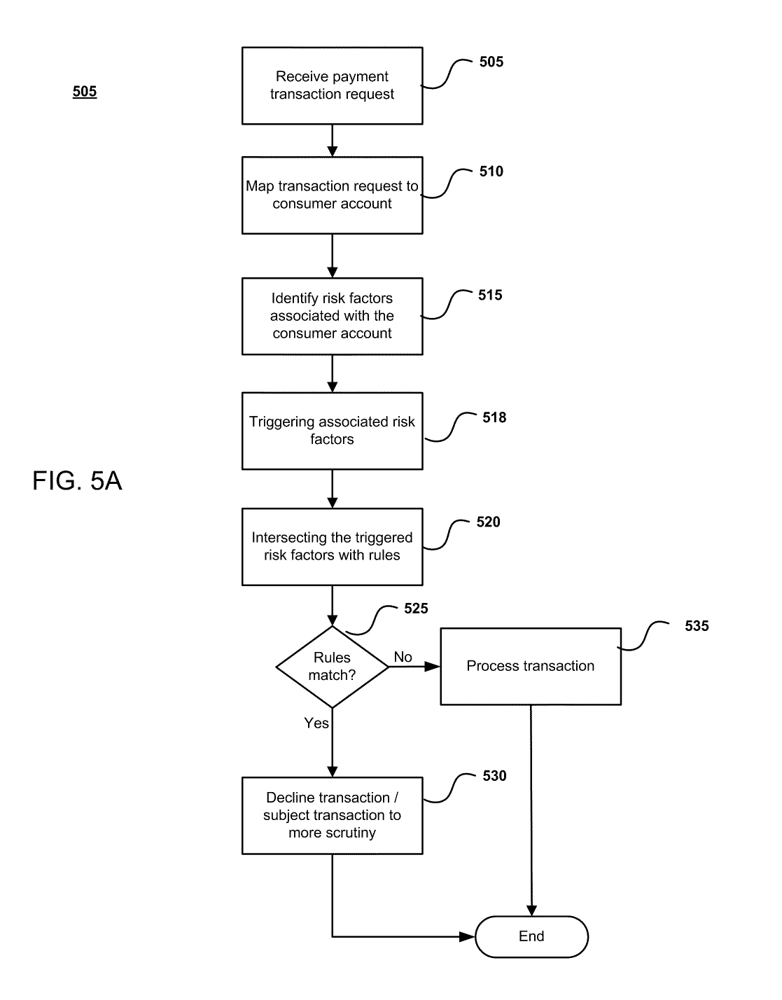

FIG. 4A is a flow diagram showing a method for associating a risk factor with a consumer account, according to an embodiment of the invention. As used herein, risk factor should be understood to be a predetermined (i.e., before the transaction) factual aspect which may be present in a transaction, and tied to a particular consumer or particular group of consumer accounts, for indicating which fraud rule(s) should be applied to the transaction.

Particular groups of consumer accounts are not tied to conventional card tiers but are grouped according to shared particular habits, behavior, or other common information which may indicate fraud or lack of fraud. Particular groups of consumer accounts can span many different card tiers. Accordingly, the fraud rules applied to particular groups of consumers are not arbitrarily tied to spending limit ranges and benefit levels associated with card tiers.

At step 405, a risk factor is created. As used herein, a “risk factor” can include a characteristic that affects the likelihood that a transaction being conducted is fraudulent. Examples of risk factors include “new account,” “high dollar,” and “online shopping.” In the “new account” example, a transaction made using a new account is riskier than a transaction conducted using an older account. This is because the old account has established a track record of non-fraudulent transactions whereas the new account number has not.

Risk factors may be created by the issuer 50, or its representatives. The payment processing network 40 may also create risk factors. A risk factor may be predetermined for individual consumer accounts or certain groups of consumer accounts. Additionally, a risk factor may be predefined according to known and established spending habits of an individual consumer. For example, a known “high spender” may have customized risk factors. Groups of consumer accounts may be defined according to demographic information, for example, by profession.

In some embodiments, a risk factor may be a singular aspect of a transaction or a combination of aspects. In other embodiments, a risk factor may be an attribute of a consumer account, which is nearly always present in every transaction of the consumer account. For example, risk factors may include the age of the account or account payment history of the consumer. For example, a risk factor may be created for a consumer with a high account balance and/or history of late payments, as new high dollar purchases may indicate the consumer may be intentionally maxing out the account before abandonment or bankruptcy.

In other embodiments, a risk factor may be a variable transaction attribute, which is not necessarily present in every transaction. For example, transaction attributes can be derived from transactional fields of the transaction, such as transaction amount, merchant category, or transaction location. Accordingly, risk factors may be associated with an account, but not necessarily applicable to a specific transaction where the associated transaction attribute is not present.

In some cases, a risk factor may not have any context in isolation. For example, a “hundred dollar” risk factor defined as a transaction amount over $100 can be supplementary to other risk factors, such as a merchant category code (MCC) for an automated fuel pump. However, without the presence of the other risk factors, the supplementary risk factor will not trigger an associated fraud rule.

A risk factor may also be tied to multiple aspects of a transaction. For example, a “high dollar online” risk factor may require a high transaction amount (e.g., over $1000), and indication that the transaction between the consumer 10 and merchant 20 takes place over the Internet 60.

A risk factor may be temporary over a time period, with a predefined start time and expiration time. For example, the time period may relate to when the consumer 10 will be in a foreign country. In one example, a risk factor may be created for that time period regarding maximum transaction amounts. In another example, a location risk factor may be created for that time period regarding transactions within the consumer's home country, where the consumer is not present.

A risk factor may override other risk factors. Accordingly, an overriding risk factor will only cause the rules it is associated with to be applied to a transaction, and prevent application of rules associated with other risk factors triggered in the transaction. For example, a “high spender” risk factor can be configured to override a “high dollar” risk factor for transactions greater than $1000, as the associated consumer account is historically tied to high transaction amounts. In another example, an “extreme high dollar” risk factor for transactions greater than $10,000 can be configured to override other risk factors, even the “high spender” risk factor. In another example, a “traveler” risk factor can override an “automated fuel pump” risk factor, as the consumer 10 of the account may be traveling by car, or the consumer 10 may be a traveling salesperson. In another example, a “low dollar” risk factor for transactions under $20 can override other risk factors and also not have an associated fraud rule, as the cost/benefit ratio of applying a fraud rule to low dollar transactions may be too high.

At step 410, the created risk factor is associated with a fraud rule. The issuer 50 can determine which fraud rules apply when the risk factor is identified in a transaction request. For example, a “high dollar” risk factor can be associated with a rule which analyzes historical spending patterns of the consumer account. In another example, an ATM risk factor is associated with a rule which analyzes recent ATM usage. More than one rule may be triggered by a risk factor. For example, a new member risk factor may trigger a transaction amount rule, a recent spending pattern rule, and a merchant category rule.

At step 415, the risk factor associated with a fraud rule is further associated with a consumer account. Accordingly, when the risk factor is identified in a transaction by the consumer account, the associated fraud rule will be applied. The cardholder database 200(b) may store the risk factor on a consumer account profile. More than one risk factor may be associated with a single consumer account.

FIG. 4B shows a user interface 420 for creating risk factors, and associating risk factors with a consumer account and fraud rules, according to an embodiment of the invention. The user interface 420 may be used by the issuer 50. The user interface 420 may be implemented in software on the remote server computer 220(b) of the issuer 50 communicatively coupled over a network with the server computer 200(a) of the payment processing network, as shown in FIG. 1. The user interface 420 is graphically generated by software on a display device and displays user inputs for creating, updating, and sending risk factor configurations. The risk factors can be uploaded to the server computer 200(a) and/or cardholder database 200(b), either directly or via the server computer of the payment processing network 40, or to a remote database associated with the issuer 50. The user interface 420 may be a secured Internet application of the server computer 200(a), and displayable and accessible over the Internet 60 on a Web browser of the client computer 220(a) of the issuer 50.

The user interface 420 includes fields which may be selected and entered by a user. As shown, multiple risk factor fields 425 make up a risk factor. The fields include a risk factor numerical descriptor, description, trigger value, override capability, and start and end dates. A field 430 is shown for entering which rules are associated with the risk factor. A field 435 is shown for entering an account or group of accounts associated with the risk factors. A selectable button 440 is included for updating and sending the risk factors to the server computer 200(a) and/or cardholder database 200(b). Selecting the button 435 also causes method 400 to be executed on the server computer 200(a) or remote server 220(b) of the issuer 50.

The user interface 420 shows a user account 1234 5678 910 and a group 206768 have been entered into field 435. Accordingly, the risk factors created using the user interface 420 apply to these particular consumers. Consumer profiles of these particular consumers may be located on the cardholder database 200(b).

As shown by field 430, a risk factor may be associated with a plurality of fraud rules, which are stored on the rules database 200(c). In the examples shown, the fraud rules numbers demonstrate that only particular fraud rules will apply when the risk factor is present. In other embodiments, fraud rules can apply to more than one risk factor. Accordingly, the risk factors of the cardholder database 200(b) cause particular fraud rules of the rules database 200(c) to apply to a particular transaction by a particular consumer or particular group of consumers.

The user interface 420 shows that a risk factor 001 has been created for high dollar transactions. Risk factor 001 is triggered when a transaction value greater than $1000 is detected, and will intersect rules 1, 14, and 19 with the transaction.

The user interface 420 shows another risk factor 014 has been created for transactions greater than $100. However, no further attributes have been defined for the rule. This is because the 100-dollar risk factor 014 is a supplementary risk factor, which alone has little or no context and will not cause a rule to be triggered. However, when associated with other risk factors the 100-dollar risk factor 014 may have context.

The user interface 420 shows another risk factor 456 has been created according to a known travel period of the consumer(s). The travel risk factor 456 is defined to trigger for all transactions, as it is related to a consumer attribute and not a transaction attribute, thus, the travel risk factor 456 will apply to every transaction of the consumer account during the travel period. As the travel period is temporary, the travel risk factor 456 risk factor has a start date and expiration date.

The user interface 420 shows another risk factor 120 has been created for automatic fuel pump (AFP) transactions. The AFP risk factor 120 is triggered when the MCC of an automatic fuel pump (5542) is detected and when the 100 dollar risk factor 014 is also triggered. Accordingly, the 100-dollar risk factor 014 is given context by risk factor 120.

The user interface 420 shows another risk factor 756 has been created for high spending account owners. The high spender risk factor 756 is defined to trigger for all transactions, as it regards a consumer attribute. Risk factor 756 has been created because the consumer has a known spending history, and can reliably make high cost purchases without warranting further investigation. Accordingly, the high spender risk factor 756 will over ride the high dollar risk factor 001, which appears to give the high dollar risk factor 001 no context. However, the high dollar risk factor 001 can still be given context by other risk factors.

The user interface 420 shows another risk factor 160 has been created for extremely high dollar transactions. The risk factor 160 is triggered when the transaction amount is greater than $10,000. The risk factor 160 has capability to override all other risk factors, even the high spender risk factor 756.

The user interface 420 shows another risk factor 011 has been created for high value online transactions. The high value online risk factor 011 is triggered when an online transaction has been identified as well as risk factor 001. The high value online risk factor 011 overrides the high spender 756 risk factor, as the consumer has little to no history of making internet purchases. Accordingly, the high dollar risk factor 001 is given context by the high value online risk factor 011, as the high spender risk factor 756 has been overridden.

The user interface 420 shows another risk factor 006 has been created for ATM transactions. The ATM risk factor 006 is triggered when the MCC value (6011) shows that a ATM is being used. The ATM risk factor 006 has a “never” override value, which means that ATM risk factor 006 can never be overridden by another risk factor.

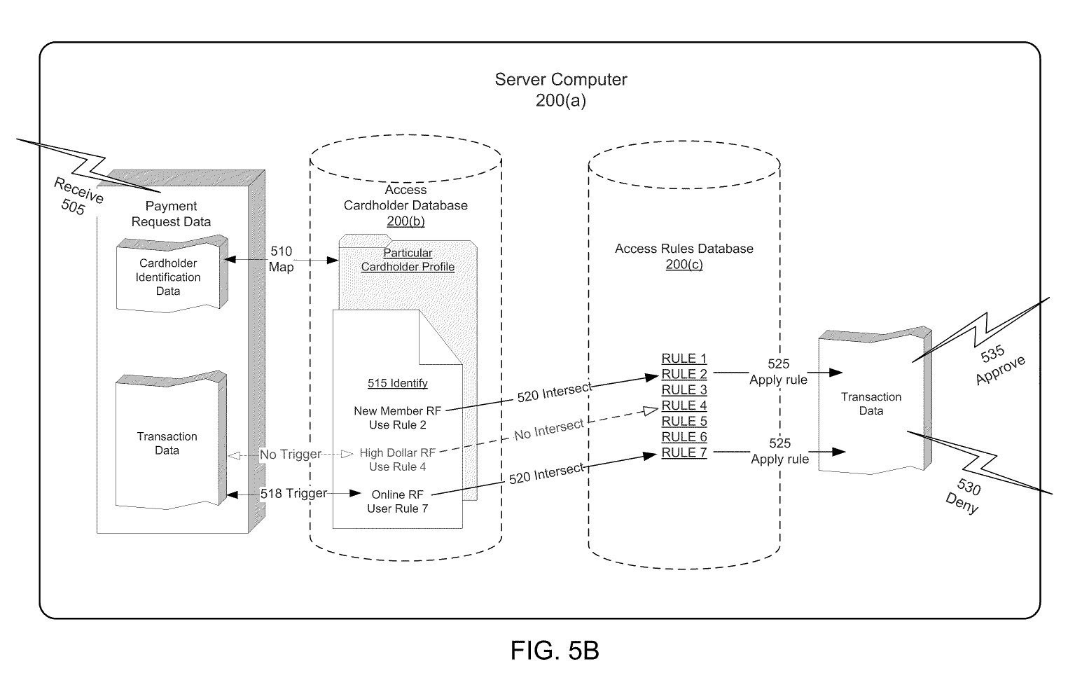

FIG. 5A and FIG. 5B are high-level and system-level flow diagrams, respectively, of a method 500 for processing a transaction, according to an embodiment of the invention.

With reference to FIG. 5A and FIG. 5B, at step 505 a server computer 200(a) receives a payment transaction request. The payment transaction request includes data including card holder identification data and transaction data.

At step 510, the server computer 200(a) uses the identification data to map the information in a payment request to a consumer account. The payment request may be embodied by an authorization request message. In the example shown in FIG. 5B, the server computer 200(a) uses the identification data to access the cardholder database 200(b) and map the request to a consumer account by correlating the identification data with a particular cardholder's profile stored on the cardholder database 200(a).

At step 515, the server computer 200(a) identifies predetermined risk factors associated with the consumer account stored in the cardholder database. In the example shown in FIG. 5B, the server computer 200(a) identifies a “new member” risk factor, a “high dollar” risk factor, and an “online” risk factor associated with the consumer account. Each risk factor is predetermined to be associated with a certain fraud rule. In this example, a “new member” risk factor is associated with rule 2, a “high dollar” risk factor is associated with rule 4, and an “online” risk factor is associated with rule 7.

At step 518, the server computer 200(a) triggers certain risk factors associated with the account according to risk factor triggering conditions stored in the cardholder profile, and transaction data present in the payment request. In the example shown in FIG. 5B, the server computer 200(a) determines that the “online” risk factor is triggered because the transaction data of the payment request indicates an online transaction. The server computer 200(a) determines that the “high dollar” risk factor is not triggered because the transaction data does not indicate a high enough dollar value. The server computer 200(a) triggers the “new member” risk factor as a matter of course because the “new member” risk factor is tied to a consumer attribute, and is always triggered during a transaction.

At step 520, the server computer 200(a) intersects the triggered risk factors with the associated rules, by retrieving the associated rules of the triggered risk factors from the rules database 200(c). In the example shown in FIG. 5B, the server computer 200(a) retrieves rule 2 according to the “new member” risk factor, and rule 7 according to the “online” risk factor. The server computer 200(a) does not intersect rule 4 of the “high dollar” risk factor, as the “high dollar” risk factor was not triggered.

At step 525, the server computer 200(a) applies the intersected rules to the transaction data. In the example shown in FIG. 5B, the server computer 200(a) applies rule 2 and rule 6 to the transaction data. The server computer 200(a) generally does not apply any non-intersected rules to the transaction data.

At step 530, the server computer 200(a) will deny or pass the transaction on to another level of scrutiny if one, all, or some of the intersected rules match the fraud conditions of the rules. In step 535, the server computer 200(a) will process the transaction if the conditions of the rules do not match the fraud conditions specified by the rules.

As shown herein, the risk factors provide an accurate application of specific fraud rules to transactions, as the risk factors are individually tailored to a particular consumer account or particular groups of consumer accounts. Accordingly, fraud rules are not applied in an arbitrary manner, which reduces processing time by avoiding non-relevant fraud rules, and provides more accurate fraud indication.

In many embodiments, the fraud rules associated with the risk factors analyze historical events and other aspects of a particular consumer, such as the flash fraud and real time filter rules described in commonly assigned and simultaneously filed U.S. patent application Ser. No. __/___,___, entitled “Event Tracking and Velocity Rules for Financial Transactions”, Attorney Docket No. 016222-050310US, the entirety of which is incorporated herein by reference.

Embodiments of the invention are not limited to the above-described embodiments. For example, although separate functional blocks are shown for an issuer, acquirer, payment processing system, server computer, or remote server, some entities perform some or all of these functions and may be included in embodiments of invention.

It should be understood that the present invention as described above can be implemented in the form of control logic using computer software in a modular or integrated manner. Based on the disclosure and teachings provided herein, a person of ordinary skill in the art can know and appreciate other ways and/or methods to implement the present invention using hardware and a combination of hardware and software.

Any of the software components, user interfaces, or methods described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method for processing a transaction, the method comprising:
receiving a payment request to approve a transaction at a server computer, the transaction associated with a consumer account;
triggering at least one risk factor from a plurality of risk factors associated with the consumer account, using the server computer;
intersecting the at least one risk factor with at least one fraud rule of a plurality of fraud rules, using the server computer; and
applying the at least one intersected fraud rule to the payment request, using the server computer.

2. The method of claim 1, wherein the plurality of risk factors are based on consumer and/or transaction attributes.

3. The method of claim 2, wherein at least one consumer attribute is account age or account payment history.

4. The method of claim 2, wherein at least one transaction attribute is an amount of the transaction, merchant category, or a transaction location.

5. The method of claim 2, wherein the transaction attributes are derived from transactional fields of the transaction.

6. The method of claim 1, wherein the at least one risk factor is pre-determined to expire.

7. The method of claim 1, wherein the plurality of risk factors are associated with the account by an issuer of the account prior to the transaction.

8. The method of claim 1, wherein the at least one intersecting risk factor overrides at least one other triggered risk factor.

9. The method of claim 1, further comprising:
identifying the plurality of risk factors associated with the consumer account before triggering the at least one risk factor, using the server computer.

10. A server computer, comprising:
a processor for executing instructions of an electrically coupled computer readable medium, the instructions for performing the method of claim 1.

11. A method for associating a fraud rule with a consumer account, the method comprising:
defining at least one risk factor regarding potential payment requests of a consumer account, using a server computer;
associating at least one fraud rule of a plurality of fraud rules with the at least one risk factor, using the server computer; and
associating the at least one risk factor with at least one consumer account, using the server computer.

12. The method of claim 11, wherein the at least one associated fraud rule is applied to a payment request if the at least one associated risk factor is triggered during a transaction.

13. The method of claim 12, wherein the at least one associated risk factor is triggered based on at least one consumer attribute unique to the consumer account.

14. The method of claim 13, wherein at least one consumer attribute is account age or account payment history.

15. The method of claim 12, wherein the at least one associated risk factor is triggered for the payment request based on at least one transaction attribute of the payment request.

16. The method of claim 15, wherein at least one transaction attribute of the transaction is an amount of the transaction, merchant category, or transaction location.

17. The method of claim 15, wherein the at least one transaction attribute of the transaction is derived from a transactional field of the transaction.

18. The method of claim 11, further comprising:
defining an expiration time for the at least one risk factor.

19. The method of claim 11, wherein the server computer performs the steps in accordance with instructions received from a remote server computer, the instructions being entered at a user interface coupled to the remote server computer.

20. A server computer, comprising:
a processor for executing instructions of an electronically coupled computer readable medium, the instructions for performing the method of claim 11.
